(19) United States
(12) Patent Application Publication
(10) Pub. No.: US 2010/0109554 A1
(43) Pub. Date: May 6, 2010

(54) ILLUMINATION DEVICE HAVING INRUSH CURRENT LIMITING CIRCUIT

(75) Inventors: Reinhard Lecheler, Neuburg/Donau (DE); Siegfried Mayer, Moosinning (DE); Bernhard Schemmel, Wessling (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/532,160

(22) PCT Filed: Apr. 25, 2007
(86) PCT No.: PCT/EP07/54046

§ 371 Date: Sep. 20, 2009

(51) Int. Cl. H05B 37/02

(52) U.S. Cl. 315/291

(57) ABSTRACT

An illumination device includes an integrated electronic ballast and a luminaire connecting terminal, that has a terminal housing, wherein there is integrated in the terminal housing an inrush current limiting circuit that is designed such that when the luminaire is switched on it prevents excessively large inrush currents by a voltage drop in the inrush current limiting circuit during the switched on phase.

### TECHNICAL FIELD

The present invention relates to a luminaire and to an electronic ballast for operating a lamp. The luminaire and the ballast are summarized here under the term of “illumination device”. What is meant here by the term of “lamp” is the luminous means, for example, a discharge lamp or a halogen incandescent lamp, or else an LED or an LED module. The term of “luminaire” in turn, means an illuminating apparatus that is designed for the installation of a lamp or already includes an installed lamp, and that has in addition to the lamp a housing, frame or a reflector for the lamp as well as a supply lead for connection to the network or battery powered operation of the lamp. In this case the invention relates only to such luminaires as include an integrated electronic ballast.

### PRIOR ART

Experience has shown that lamps operated via electronic ballasts can experience relatively high inrush current peaks being switched on in particular when the ballasts have relatively large capacitors on the input side. Such capacitors are widespread for many types of ballast, for example, as an intermediate circuit storage capacitor. The inrush current peaks lead to loads on the components affected by the current peaks and can, furthermore, cause fuses to blow, in particular when a plurality of ballasts with such properties are operated together on one fuse. The inrush current peaks of low importance for continuous technical operation can therefore substantially reduce the number of the ballasts that can be operated together on one fuse.

On the other hand, the production of ballasts and luminaires is subject to a substantial cost pressure such that it is impractical in many cases to consider additional measures for current limitation, for example, by means of power factor correction circuits with an inherent current limiting function.

### SUMMARY OF THE INVENTION

The invention is based on the technical problem of specifying an improved electronic ballast for a lamp, and an improved luminaire with an integrated ballast which offer an economic solution to eliminating or ameliorating the difficulties associated with inrush current peaks.

The invention is directed, firstly, to a luminaire having an integrated electronic ballast and a luminaire connecting terminal, that has a terminal housing, characterized in that there is integrated in the terminal housing an inrush current limiting circuit that is designed such that when the luminaire is switched on it prevents excessively large inrush currents by a voltage drop in the inrush current limiting circuit during the switched on phase, and secondly to an electronic ballast, having a ballast connecting terminal that has a terminal housing, characterized in that there is integrated in the terminal housing an inrush current limiting circuit that is designed such that when the luminaire is switched on it prevents excessively large inrush currents by a voltage drop in the inrush current limiting circuit during the switched on phase.

Preferred refinements are specified in the dependent claims.

It may be stated as a precaution that the disclosure also relates to a method for operating a lamp having an electronic ballast, or a luminaire, and that the various features are also intended to provide for the method category as disclosed.

The basic idea of the invention consists in integrating an inrush current limiting circuit in a connecting terminal of the luminaire or the ballast. The inrush current limiting circuit is defined in the most general sense by the fact that in the course of switching on it firstly produces in the switched on phase a voltage drop in the line in which the inrush current peak would otherwise occur and that this voltage drop then vanishes or decreases substantially relatively quickly, for example, in a time of at most 500 ms.

In a concrete refinement, the voltage drop can be produced via an open additional switch in the line which is firstly closed with a delay, specifically in the range of small instantaneous values of the applied supply voltage, preferably at the voltage zero. When the supply of the ballast is then begun with small or even virtually zero supply voltage values, the inrush current is limited, and it is possible, in particular for capacitors in the ballast to be charged without any problems as a consequence of the small supply voltage values.

In another refinement, the voltage drop in the inrush current limiting circuit is produced by an initially high resistance in the line in which the inrush current peak would otherwise occur. This resistance, as well, should then vanish, or be reduced by a factor of at least 50, in a relatively short time, for example at most 500 ms. The initial resistance for the purpose of limiting the inrush current depends on the wiring and can, for example be in the range from 50 Ω to 1 Ω.

The integration in the terminal housing means that the connecting terminal and the inrush current limiting circuit have a common housing, which, of course does not mean that the entire housing of the ballast or of the luminaire is involved. It is thus possible for them to be easily installed and removed as a unitary component.

The integration of this limiting circuit in the connecting terminal has the advantage that the ballast or the luminaire can be protected in a particularly simple way and without intervention in the actual circuit of the ballast. The connecting terminal provided with the inrush current limiting circuit can be fabricated as a separate part and used in the technical field that is otherwise unchanged. Consideration is given here both to connecting terminals via which the luminaire is connected as a whole to, for example, a network supply lead and those that belong to the ballast and can be connected to a luminaire connecting terminal via a further supply lead. Also to be taken into consideration, of course, are the cases in which the luminaire connecting terminal and the ballast connecting terminal are identical and are installed at the ballast.

In particular, the inrush current limiting circuit can be used in a to a certain extent modular way, that is to say be added to those luminaires or ballasts in the case of which inrush current peaks constitute a particular problem or that are targeted specifically with this performance characteristic, and therefore are also intended to be sold at a somewhat higher price. it is possible in this way to combine the advantages of unchanged mass production of the ballasts and/or luminaires with a simple and pragmatic solution to the limiting of the inrush current.

A favorable possibility for implementing the inrush current limitation consists, for example, in an “NTC” (Negative Temperature Coefficient) thermistor, that is to say a resistance element having a strongly increasing conductivity at an increasing temperature. Upon switching on, the NTC thermistor is firstly still cold or at room temperature and therefore has a relatively high resistance. The current can thus be limited to acceptable values, but heats the NTC thermistor up relatively quickly and brings it thereby into a state of substantially lower resistance. In continuous operation, the low power loss in the NTC thermistor suffices to maintain an adequately low resistance value therein. Depending on the ambient thermal conditions and on the design of the NTC thermistor and load current, it may be necessary here to set a suitable temperature and resistance equilibrium.

Another possibility of implementing the inrush current limiting circuit is a relay with a parallel connected resistor. When the relay is open, the resistor firstly prescribes the initial current limitation. The relay can either be connected via a separate timer circuit and then bridge the resistor (for example can be closed by the applied voltage and a time delay element), or can also be driven directly by the applied voltage and is then closed with a time delay which is typical for relays. It is thus possible to add a further timer or delay circuit, or else not, depending on the technical data of the relay used, that is to say its pickup delay induced by design.

One advantage over the previously described variant consists in that in continuous operation the resistance value can be particularly low, and the resistance value can be set freely when limiting the inrush current. Furthermore, there are no thermal inertias present such as is the case with NTC thermistors, and so even fast switch off and reclosing processes present no problems.

One alternative to the outlined combination of relay and resistor consists in a time controlled switching transistor with a parallel connected resistor. By contrast with the “classic” relay, the switching transistor is practically free from wear. The fact that the circuit structure is more complex in principle may not necessarily entail a higher price.

Instead of the switching transistor, it is also possible to use a thyristor, TRIAC or IGBT that is ignited or switched on in a time controlled fashion after the switching on and thereby acquires a low resistance.

In the case of the two previously described variants, the time control can be implemented via an RC element, but can also be undertaken in an advantageous way by a microcontroller provided in any case in many modern electronic ballasts, or by another electronic controller of the ballast.

Finally, the inrush current can also be limited via the controlled delayed switching on of a transistor. This controlled switching on can mean a time controlled slow switching on. The word “slow” means here that the transistor reaches its full conductivity during the process of switching on over a time interval of a few 10 ms. To this end, the transistor, for example, a MOSFET, is driven with an appropriate time control. The parallel resistor can therefore also be eliminated if the switching transistor can be adequately loaded.

However, it is preferred to provide an additional circuit between a control terminal of the transistor and a further one of its terminals that, in response to the current through the transistor that is to be limited, controls the driving of the control terminal, that is to say, in particular, limits the potential at the control terminal. During the switching on process, in which current peaks would otherwise occur, such a circuit limits the current through the transistor by virtue of the fact that the transistor does not, close completely. After the actual switching on process is terminated, when inrush current peaks are no longer to be feared, the circuit can preferably switch on the transistor completely, although this is not imperative. For the rest, reference may be made to the explanations relating to the exemplary embodiments.

Finally, it is advantageous when a thermal fuse is provided, in particular one that is likewise integrated in the terminal housing. This can be a simple fusible link or another thermally tripping fuse. It is thereby possible to prevent the inventive components causing a danger in the case of a short circuit in the ballast.

The invention is explained in more detail below with the aid of exemplary embodiments, the individual features also being able to be essential to the invention in other combinations, and relating to the categories of device and method.

### BRIEF DESCRIPTION OF THE DRAWINGS

FIG. 1 shows a schematic circuit diagram of an inventive illumination device having an NTC thermistor as first exemplary embodiment.

FIG. 2 shows a schematic circuit diagram of an inventive illumination device having a thyristor and parallel resistor, as second exemplary embodiment.

FIG. 3 shows a schematic circuit diagram of an inventive illumination device having a switching transistor and parallel resistor as third exemplary embodiment.

FIG. 4 shows a schematic circuit diagram of an inventive illumination device having a relay and parallel resistor, as fourth exemplary embodiment.

FIG. 5 shows a schematic circuit diagram of an inventive illumination device having a linearly operated MOSFET as fifth exemplary embodiment.

FIG. 6 shows a schematic circuit diagram of an inventive illumination device having a microcontroller as drive source for a switching transistor, as sixth exemplary embodiment.

FIG. 7 shows a schematic circuit diagram of an inventive illumination device having a clocked MOSFET and a smoothing circuit, as seventh exemplary embodiment.

FIG. 8 shows a schematic circuit diagram of an inventive illumination device having a MOSFET switched as a function of voltage, as eighth exemplary embodiment.

FIG. 9 shows current and voltage time profile graphs for an illumination device without an inventive inrush current limiting circuit.

FIG. 10 shows current and voltage time profile graphs for an illumination device having an inventive inrush current limiting circuit.

### PREFERRED DESIGN OF THE INVENTION

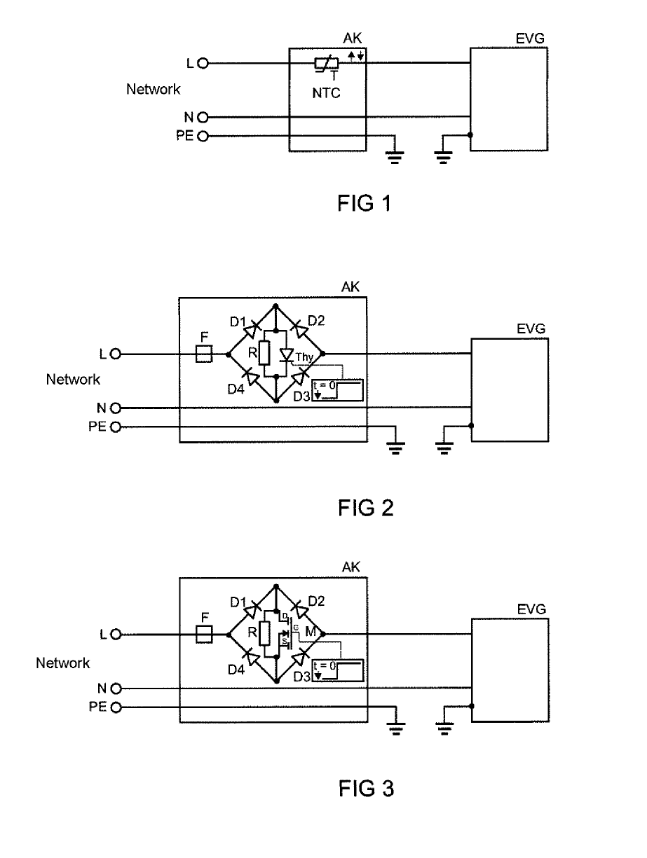

The wiring of an inventive inrush current limiting circuit in a luminaire is illustrated in FIG. 1, in the context of a heavily schematized block diagram. Illustrated on the left is a network terminal, denoted by “network”, with a phase conductor L, a protective ground PE and a neutral conductor N, that is guided to a luminaire connecting terminal AK via a network supply lead (not further separated out). The luminaire connecting terminal AK is a standard plastic housing—represented by the rectangle—having installed terminal contacts, known per se, for the lines L, PE and N. According to the invention, an NTC thermistor NTC is connected here into the phase line L.

The protective ground PE is guided to a luminaire grounding contact, specifically a conducting connection to the luminaire housing. Also connected to the luminaire housing is a protective earth connection (not illustrated) of an electronic ballast EVG (drawn in on the right) that is otherwise connected to the phase conductor L and the neutral conductor N via the connecting terminal AK in each case.

When switching on is carried out, the voltage present at the phase L is suddenly applied to the NTC thermistor NTC and to the EVG via the latter as a consequence of its residual conductivity. Present at the EVG input is a diode rectifier bridge via which an intermediate circuit capacitor (not illustrated) is charged with supplying a transformer of the ballast with direct voltage. The NTC thermistor NTC which is initially of high resistance, does not permit a large charging current and so the charging process of the intermediate circuit capacitor in the ballast is somewhat delayed. During this time, the suitably dimensioned NTC thermistor NTC is sufficiently heated in order to go over into a state of low resistance. The charging process is thereby terminated, and the operation of the ballast and lamp is performed otherwise as usual.

The residual resistance of the NTC thermistor NTC does not play an important role in this exemplary embodiment. After the switching off, it is necessary to wait sufficiently long until the NTC thermistor NTC has cooled down before the protective function is once again available. However, this disadvantage is tolerable in many instances, at any rate when a faster switch off and reclosing operation affects only one ballast or a small number of ballasts on a common fuse.

FIG. 2 shows a second exemplary embodiment, and corresponds largely to FIG. 1, the NTC thermistor NTC being replaced here by an inrush current limiting circuit illustrated in detail. This circuit has a rectifier bridge constructed from four diodes D1-D4. Connected between the two nodes of the bridge, which do not correspond to the incoming phase lead or outgoing phase lead, is a resistor R and parallel thereto, a thyristor

Thy of the same polarity as the diodes D1-D4. Instead of this, it would be equally possible to select a TRIAC or IGBT. The thyristor Thy is driven by a timer circuit, illustrated symbolically by a time profile diagram, which can be implemented by a simple RC element. In the case of the two half waves of different polarity of the phase L, shortly after switch on and before the ignition of the thyristor Thy, the resistor lies in the current path to the ballast. When the thyristor Thy is ignited, it short circuits the resistor R as a consequence of its conductive state, and thereby terminates the limitation of the inrush current. F is a thermal fuse that is likewise integrated.

Both exemplary embodiments relate to a luminaire connecting terminal AK. However, it can also easily be transferred to a ballast connecting terminal. To this end, it is necessary merely to regard the terminal AK as an integral component of the ballast. This ballast connecting terminal could then be connected to a luminaire connecting terminal via a separate line, or even already form the luminaire connecting terminal.

FIG. 3 shows a third exemplary embodiment, which modifies the second exemplary embodiment from FIG. 2 to the extent that instead of the thyristor use is made there of a switching transistor, specifically a power MOSFET M. The source, gate and drain contacts are denoted by S, G and D, respectively. Otherwise, the explanations relating to FIG. 2 apply.

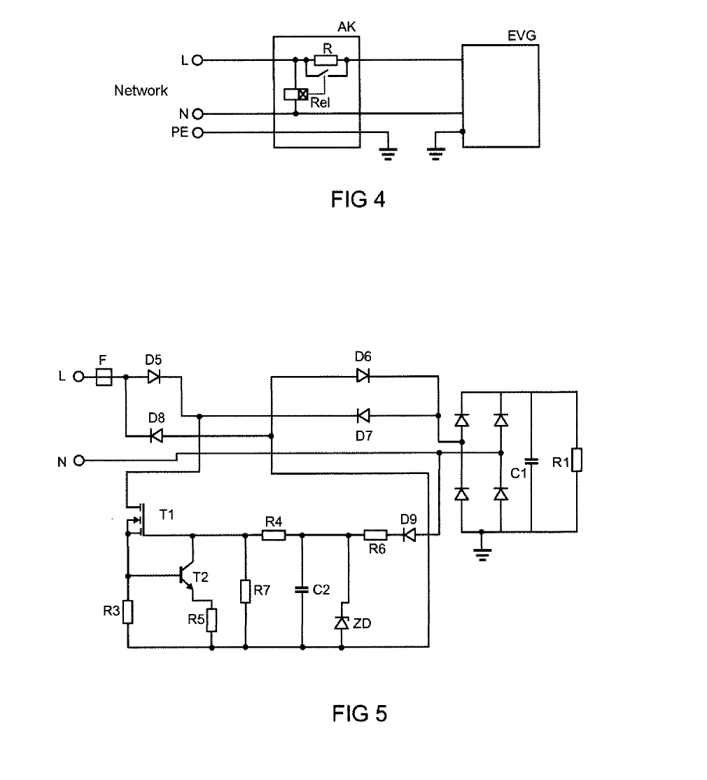

FIG. 4 shows a fourth exemplary embodiment, which can be most easily explained by comparison with FIG. 1. The NTC thermistor NTC is replaced here by a customary ohmic resistor R that, however, typically exhibits 220 Ω, as in the second and third exemplary embodiments. The resistor R can be bridged by a classic relay, denoted by Rel, which is connected with its control contacts in the way shown, between the phase conductor

L and neutral conductor N, and is therefore driven with the switching on process. The part of the relay that is marked with an X is intended in this case to symbolize pickup delay that either is determined by design, or is implemented by a delay circuit, for example an RC element.

FIG. 5 shows schematically a circuit where an inrush current is limited by controlling the switching on of a MOSFET T1. L and N once again denote phase and neutral conductor; F again denotes an integrated thermal fuse. The MOSFET Ti is connected into the incoming phase lead L via four rectifier diodes D5-D8 such that the supply current always flows through it with the correct polarity. For the rest, the incoming phase lead L and the neutral conductor N are connected to a customary rectifier bridge, not illustrated separately in FIGS. 1 to 4, composed of four rectifier diodes in the input of the ballast. The intermediate circuit capacitor of the ballast is denoted by C1 and here represents the input capacitance of the ballast that is responsible for the inrush current peaks. R1 (for example 10 kΩ) denotes an ohmic resistance that stands here only symbolically for the load formed by the ballast.

FIG. 5 also shows that the gate of the MOSFET T1 is connected to the neutral conductor via two resistors R4 (for example, 1 kΩ) and R6 as well as a diode D9. The resistor R6, which is dimensioned here with 100 kΩ, by way of example, serves the purpose of electrical isolation and forms a smoothing element together with a capacitor C2 of, for example, 3.3 μF. A resistor R7, for example, of 1 MΩ, serves to discharge the capacitor C2 in the switched off state.

The supply current of the phase conductor L through the MOSFET T1 is guided through a small resistor R3 of, for example, 1 Ω, in order to produce a proportional voltage drop. This voltage drop is used to monitor the gate voltage of the MOSFET T1, specifically via a bipolar (npn) transistor T2, the collector of which is connected to the gate, the base of which is connected to source and the emitter of which is connected via a further resistor R5 (approximately 22 Ω) and the already-mentioned resistor R3 to its base and thus to the source connection of the MOSFET T1.

Finally, the gate voltage is denoted by a zener diode ZD with a threshold voltage of approximately 18 V.

After the phase has been switched on at L, the capacitor C2 is slowly charged via the resistor R6, and produces an increasing drive voltage for the gate of the MOSFET T1. As soon as a supply current begins to flow through the MOSFET T1 in the switching on process for the latter, a voltage drops across the resistor R3 and reduces the gate voltage of the MOSFET T1 upon reaching the emitter base threshold voltage of the bipolar transistor T2.

The internal resistance of the MOSFET T1, which is increased in the switching on process, can thereby be used to limit the inrush current determined by the charging of the capacitor C1. As soon as the capacitor C1 is charged to a substantial degree, the supply currents for the ballast drop so steeply that no further voltage adequate for closing the bipolar transistor T2 drops across the resistor R3. In continuous operation, the bipolar transistor T2 therefore remains open and it is consequently possible to close the MOSFET T1 completely via the voltage present across the capacitor C2 in order not to produce any unnecessary losses.

For the rest, the emitter base threshold voltage of the bipolar transistor T2 is so small at its order of magnitude 0.7 V that the resistor R3 can be of correspondingly small dimension and therefore be dimensioned with low loss.

In the case of alternative embodiments with a similar function, the bipolar transistor may also be replaced by a zener diode having a correspondingly lower threshold voltage that limits the gate voltage across the MOSFET T1 when it switches through as a consequence of a voltage drop across the resistor R3. The threshold voltages required here would, however, be higher than the emitter base threshold voltage of the bipolar transistor T2 and would therefore lead to a somewhat larger dimensioning of the resistor R3, that is to say to somewhat higher losses.

Conversely, the circuit illustrated in FIG. 5 could also be designed yet more ambitiously by replacing the bipolar transistor T2 serving here to be represented in principle, by an instrument amplifier circuit with operational amplifiers. It would be possible thereby to avoid fluctuations owing to the temperature sensitivity and the manufacturing tolerance, and it would also be possible further to reduce the threshold value of 0.7 V.

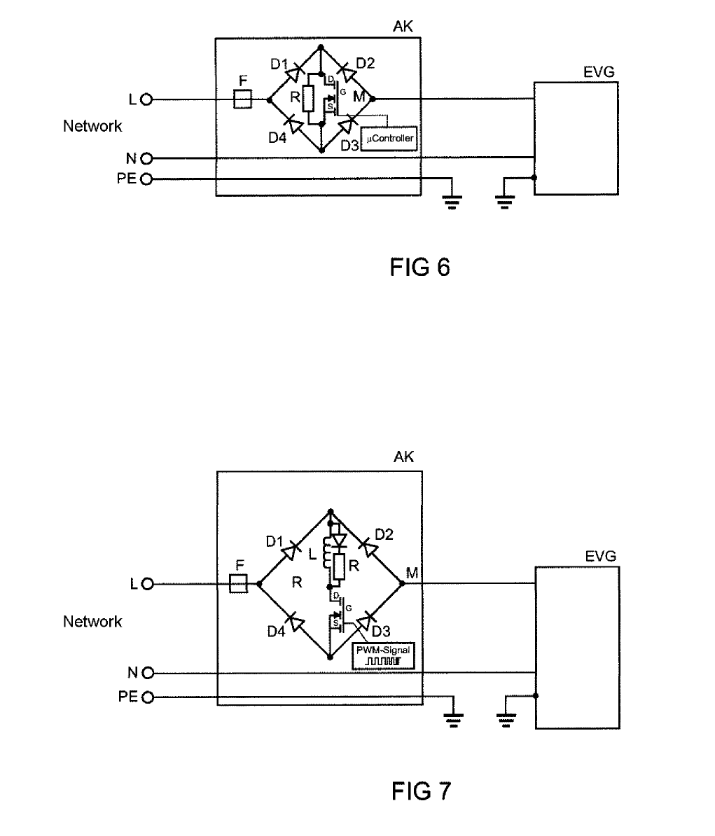

FIG. 6 shows a further exemplary embodiment, in which, as in FIG. 3, instead of being driven by the simple timer circuit illustrated there, a MOSFET M is driven via a function of a microcontroller that is present in any case in many instances of electronic ballasts and could therefore acquire a connection to the gate connection of the MOSFET M with a virtually nonexistent additional outlay. In the case of ballasts without a current de-limiting function, this connection would then remain functionless and so nothing stands in the way of the modular use of the inventive connecting terminals. This holds, in particular, for the integration of the connecting terminal in the ballast. For the rest, the thyristor from FIG. 2 can also be driven in a corresponding way via the microcontroller.

FIG. 7 shows a further exemplary embodiment, in which, as in FIGS. 3 and 6, a MOSFET is driven via a pulse width modulated PWM signal, that is to say in a clocked fashion. Consequently, an intermittent supply current is produced that is transformed into a quasi-continuous current by a serial smoothing circuit composed of an inductor L, a rectifier diode and a resistor R.

The time constant resulting from L and R must therefore be adapted to the clock frequencies of the PWM signal. The diode corresponds to the polarity of the rectifier bridge D1-D4. This exemplary embodiment shows that a controlled switching on process can also be implemented for control in a digital way in the case of the exemplary embodiment from FIG. 5, the crucial factor in the case of the exemplary embodiment in FIG. 7 not being the internal resistance of the MOSFET that exists during the switching on process in the environment of the threshold voltage.

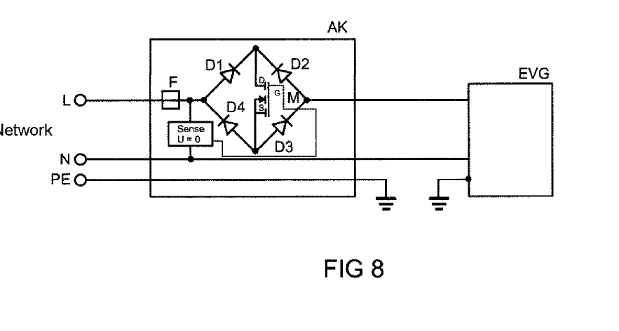

FIG. 8 shows a last exemplary embodiment having common features with the exemplary embodiments from FIG. 3 and FIG. 4. In relation to the exemplary embodiment from FIG. 3, here the MOSFET M is not switched on in accordance with a prescribed time schedule in a delayed fashion, but as a response to the acquisition of the voltage between phase L and neutral conductor N. A switch is made at the next possible voltage zero so that the charging process of the input capacitor of the ballast is formed as a consequence of the voltage initially rising only in small values, without current rushes at a problematic level. It is therefore possible to omit the parallel connected resistor R and, by comparison with the exemplary embodiment from FIG. 5, the internal resistance of the MOSFET M likewise does not play an important role in the switching on process.

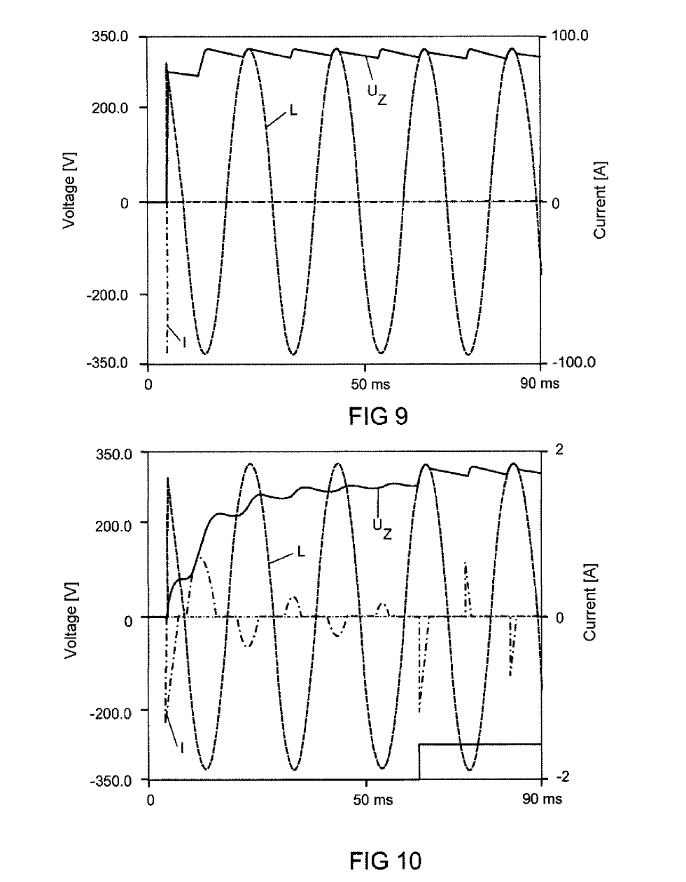

FIG. 9 and FIG. 10 show by comparison the action of the inventive inrush current limiting circuits, doing so with the aid of measurements. In this case, the horizontal axis shows in both cases the time scale from 0 to 90 ms. The vertical axis shows, plotted on the left, a voltage scale from −350 V to +350 V, in each case, and, plotted on the right, a current scale from −100 A to +100 A in FIG. 9, and from −2 A to +2 A in FIG. 10.

The instant of time at the start of the graphs corresponds to the actual switching on instant. In FIG. 9, this switching on instant (for example 5 ms) is selected such that precisely a peak value of the phase L is reached, specifically at just under 350 V. The voltage at the phase L oscillates sinusoidally. A sawtooth-like graph in the upper- region, denoted by U_{z}, shows the voltage across the intermediate circuit capacitor, mentioned above, in the ballast. Virtually from the start, said voltage lies at the peak value of the supply voltage and drops synchronously therewith as a consequence of the load inside the ballast, and is charged anew with each new peak value of the phase L. The consequently very fast charging of the intermediate circuit capacitor at the switching on instant is to be seen in a current pulse I which is virtually infinitesimally short in FIG. 9 and immediately merges into a current curve virtually remaining at 0 on the illustrated scale. The initial inrush current is therefore of the order of magnitude of 100 A (it is illustrated in FIGS. 9 and 10 with the sign interchanged so that it can be detected next to the voltage curve L).

By contrast therewith, FIG. 10 shows a very much slower charging process of the intermediate circuit capacitor. In the case of the inventive variant in FIG. 10 as well, the switching on process (approximately at 5 ms) is performed virtually with the peak value of the phase L. The slightly smaller triangle below the initial triangle of the phase L represents the first charging current pulse I. However, the latter is to be related to the vertical current scale (altered here) and its amplitude remains at below 1.5 A. In a fashion synchronized with the sinusoidal oscillations of the phase, there follow thereupon two quasisinusoidal charging current pulses that decrease somewhat in amplitude and temporal extent and still have subsequently smaller current amplitudes. At approximately 60 ms, the time signal occurs in accordance with the second and third exemplary embodiments from FIGS. 2 and 3, respectively, (or the NTC thermistor NTC for FIG. 1 would be sufficiently hot, or the relay Rel from FIG. 4 would be switched on). This is illustrated in FIG. 10 at the very bottom by the rectangularly rising curve. Thereupon, the amplitudes of the charging current peaks increase again because of the now omitted inrush current limiting resistor R, but said peaks constantly become shorter over time because of the increasing charging of the intermediate circuit capacitor, which is independent of the switchover process. They are stabilized at an amplitude of much less than 1 A, compare the right-hand half of FIG. 10. The voltage profile U_{z} therefore exhibits the sawtooth profile from FIG. 9 in the right-hand half, but in the left-hand half of FIG. 10 it exhibits a rise that is modulated with the same period although being smeared over the abovementioned time of 60 ms. Consequently, the invention does not provide the full intermediate circuit capacitor voltage until after a delay of a few 10 ms, but in this case the inrush current peaks can be reduced always by a factor of 100.

1. An illumination device, comprising: an integrated electronic ballast and a luminaire connecting terminal, that has a terminal housing,
wherein there is integrated in the terminal housing an inrush current limiting circuit that is designed such that when the luminaire is switched on it prevents excessively large inrush currents by a voltage drop in the inrush current limiting circuit during the switched on phase.

2. An illumination device, comprising: a ballast connecting terminal that has a terminal housing,
wherein there is integrated in the terminal housing an inrush current limiting circuit that is designed such that when the luminaire is switched on it prevents excessively large inrush currents by a voltage drop in the inrush current limiting circuit during the switched on phase.

3. The illumination device as claimed in claim 1, wherein the inrush current limiting circuit has a voltage monitoring circuit and a controllable switch and is designed so as not to close the controllable switch after the luminaire has been switched on until a voltage zero.

4. The illumination device as claimed in claim 1, wherein the inrush current limiting circuit is designed such that when the luminaire is switched on it initially provides a high resistance that is thereupon reduced.

5. The illumination device as claimed in claim 4, wherein the inrush current limiting circuit has an NTC thermistor.

6. The illumination device as claimed in claim 4, wherein the inrush current limiting circuit has a relay with a parallel connected resistor.

7. The illumination device as claimed in claim 4, wherein the inrush current limiting circuit has a time controlled switching transistor with a parallel connected resistor.

8. The illumination device as claimed in claim 4, wherein the inrush current limiting circuit has a component selected from a group consisting of: a time controlled thyristor; a TRIAC; and an IGBT with a parallel connected resistor.

9. The illumination device as claimed in claim 7, wherein the time control is performed via a microcontroller integrated in the electronic ballast.

10. The illumination device as claimed in claim 4, wherein the inrush current limiting circuit has a transistor that is switched on under control.

11. The illumination device as claimed in claim 10, wherein connected between a control terminal of the transistor and a further terminal of the transistor is a circuit that limits the control terminal potential in response to the current conducted in the transistor.

12. The illumination device as claimed in claim 1, which has a thermal fuse integrated in the terminal housing.

13. The illumination device as claimed in claim 1, being configured as a luminaire.

14. The illumination device as claimed in claim 2, being configured as an electronic ballast.

15. The illumination device as claimed in claim 14, wherein the inrush current limiting circuit has a voltage monitoring circuit and a controllable switch and is designed so as not to close the controllable switch after the luminaire has been switched on until a voltage zero.

16. The illumination device as claimed in claim 14, wherein the inrush current limiting circuit is designed such that when the luminaire is switched on it initially provides a high resistance that is thereupon reduced.

17. The illumination device as claimed in claim 16, wherein the inrush current limiting circuit has an NTC thermistor.

18. The illumination device as claimed in claim 16, in which the inrush current limiting circuit has a relay with a parallel connected resistor.

19. The illumination device as claimed in claim 16, wherein the inrush current limiting circuit has a time controlled switching transistor with a parallel connected resistor.

20. The illumination device as claimed in claim 16, wherein the inrush current limiting circuit has a component selected from a group consisting of: a time controlled thyristor; a TRIAC; and an IGBT with a parallel connected resistor.
